(19) United States
(12) Patent Application Publication
(10) Pub. No.: US 2025/0298948 A1
(43) Pub. Date: Sep. 25, 2025

(54) SYSTEM AND METHOD FOR DESIGNING CLOCK MANAGEMENT UNIT USING A NO-CODE APPROACH

(71) Applicant: ITDA SEMICONDUCTOR CO., LTD., Hwaseong-si (KR)

(72) Inventors: Ingyu KIM, Hwaseong-si (KR); Hoyeon JEON, Seongnam-si (KR); Ahchan KIM, Hwaseong-si (KR)

(73) Assignee: ITDA SEMICONDUCTOR CO., LTD., Hwaseong-si (KR)

(21) Appl. No.: 19/083,561

(22) Filed: Mar. 19, 2025

(30) Foreign Application Priority Data
Mar. 21, 2024 (KR) 10-2024-0039030

(51) Int. Cl. G06F 30/32; G06F 117/04

(52) U.S. Cl. CPC G06F 30/32; G06F 2117/04

(57) ABSTRACT

Disclosed are clock management unit design system and method for designing an internal function module of clock elements constituting a clock management unit and connections between the clock elements using a no-code approach. A clock management unit design system using a no-code approach includes: a memory configured to store at least one instruction; a clock component storage configured to store clock component information constituting a clock management unit; a hardware code logic storage configured to store hardware code logic for generating a designed clock management unit as hardware code; and at least one processor configured to execute the at least one instruction stored in the memory

### CROSS-REFERENCE TO RELATED APPLICATION

This application claims the benefit of and priority to Korean Patent Applications No. 10-2024-0039030, filed on Mar. 21, 2024, which is incorporated by reference herein in its entirety.

### TECHNICAL FIELD

The present disclosure relates to a system and a method for designing a clock management unit of a system on chip, and more particularly, to a system and a method for designing internal function modules of clock elements constituting the clock management unit and connections between clock elements using a no-code approach.

### RELATED ART

A system-on-chip (SoC) refers to a technology for integrating various function blocks such as a central processing unit (CPU), memory, interface, digital signal processing circuits, and analog signal processing circuits into a single semiconductor integrated circuit to implement a computer system or other electronic systems, or an integrated circuit (IC) integrated according to the technology. The SoC is evolving into a more complex system that includes various function blocks such as processors, multimedia, graphics, interfaces, and security features.

In general, power and clock design is important for a system-on-chip. A power and clock design process for a system-on-chip may include a power and clock diagram drawing stage, a Verilog coding and scripting stage, a first documentation stage, a Unified Power Format (UPF) and Standard Design Constraint (SDC) file generation stage, an implementation layout design stage, a second documentation stage, a design-for-testability (DFT) controller insertion stage, a hardware system analysis stage, and a software optimization stage.

The power and clock diagram drawing stage is the stage in which a power and clock structure is visually represented and drawn as a block diagram to illustrate the power domain and clock tree. In the power and clock diagram drawing stage, clock elements and their link relationships are simply represented in a diagram. The Verilog coding and scripting stage is the stage in which the register transfer level (RTL) design of hardware is performed by writing Verilog code and scripts used to define and implement the functions of an SoC. That is, a developer manually generates register transfer level (RTL) code based on the results of the power and clock diagram drawing stage.

The first documentation stage is the stage for documenting the design intent and structure at the beginning of a project, in which various types of documents, such as requirement specifications, architecture designs, and power and clock diagrams required by stakeholders such as the verification team and the software development team, are created.

The UPF and SDC file generation stage is the stage in which Unified Power Format (UPF) and Standard Design Constraint (SDC) files are generated to control power management and timing constraints, and the necessary inputs for hardware synthesis are produced.

The implementation layout design stage is the stage in which the actual layout of an SoC chip is designed and placed at the gate level. The second documentation stage is the stage in which various documents are updated and refined to reflect changes in the design and implementation. The DFT controller insertion stage is the stage in which a DFT controller and logic circuits for testing and debugging are designed and integrated into an SoC. The hardware system analysis stage is the stage in which the operation of the hardware is verified and analyzed through simulation and validation to ensure the accuracy and efficiency of the design. The software optimization stage is the stage in which software performance is enhanced by profiling and optimizing the software code running on the SoC.

In each stage of an SoC design process, various stakeholders independently perform the work related to their respective stages, and the information required at each stage may differ. In other words, the information required for the first half of the process may differ from that required for the second half. For this reason, the initial design work produced by workers in the first half of a project may reveal issues during simulation and verification in the second half, requiring the first half of the work to be repeated to resolve these issues. Additionally, if the requirements or design goals change during the project, the initial design work may need to be repeated. As multiple stages are repeated, various stakeholders must reflect changes from other stages and repeat similar tasks, resulting in significant time and labor costs in SoC design.

### SUMMARY

The purpose of the present disclosure is to provide a system and a method for designing hardware code corresponding to internal function modules of individual clock elements constituting a clock management unit and connections between the clock elements using a no-code approach, considering the settings required in a clock design process of a system-on-chip to solve the above-described problems.

The present disclosure may be implemented in various ways, including an apparatus (system), a method, a computer program stored in a computer-readable medium, or a computer-readable medium having a computer program stored therein.

According to an embodiment of the present disclosure, a clock management unit design system using a no-code approach includes: a memory configured to store at least one instruction; a clock component storage configured to store clock component information constituting a clock management unit; a hardware code logic storage configured to store hardware code logic for generating a designed clock management unit as hardware code; and at least one processor configured to execute the at least one instruction stored in the memory, wherein the at least one instruction comprises instructions to: set auto clock gating of the clock management unit, design a new clock instance by setting values of a register field defining a function of the new clock instance based on previously generated clock instance information included in the clock management unit and the clock component information, activate a function module of the new clock instance based on whether the auto clock gating of the clock management unit is set and the setting values of the register field of the new clock instance, and generate hardware code for the activated function module, hardware code for a register module for operating the activated function module, hardware code for a port for connecting the register module and the activated function module, and hardware code for connection based on the setting values of the register field of the new clock instance, activated function module information of the new clock instance, and the hardware code logic.

In some embodiments, the at least one instruction may further include instructions to: activate an adapter function module of the new clock instance when the auto clock gating of the clock management unit is set.

In some embodiments, the connection may include a clock line and a handshake signal line.

In some embodiments, the at least one instruction may further include instructions to: generate the new clock instance based on the previously generated clock instance information and the clock component information, determine a field value of a base register for setting a basic function of a clock source corresponding to the new clock instance, and determine a field value of an extension register for setting an extended function of the new clock instance.

In some embodiments, the at least one instruction may further include instructions to: activate a basic function module for performing the basic function of the new clock instance, and when the field value of the extension register for setting the extended function of the new clock instance is set to a specific value, activate an extended function module for performing the extended function.

In some embodiments, the clock component information may include: a basic function module for performing a basic function and an extended function module for performing an extended function for each clock component, an address range allocated to each clock component, an alignment size of each clock component, a base register offset size of each clock component, an extension register offset size of each clock component, and configuration field information for each clock component.

In some embodiments, the configuration field information for each clock component may include a field name, a bit position, a bit size, an access permission, and an initial value.

In some embodiments, a start address of the register of the new clock instance may be determined as a value obtained by adding a start address and an alignment size of a register of the previously generated clock instance.

In some embodiments, the clock component may be one of a PLL controller component, a clock divider component, a clock multiplexer component, and a clock gate component.

In some embodiments, the clock component may be the clock divider component, the field of the extension register of the new clock instance may include at least one of a power down field, a throttle field, and a custom field, and the clock divider component may include at least one of an override function module, a throttle function module, and a custom function module,

In some embodiments, the clock component may be the clock multiplexer component, the field of the extension register of the new clock instance may include at least one of a throttle field and a custom field, and the clock multiplexer component may include at least one of a throttle function module and a custom function module,

In some embodiments, the clock component may be the clock gate component, the field of the extension register of the new clock instance may include at least one of a shortstop field, an early wakeup field, and a custom field, and the clock gate component may include at least one of a shortstop function module, an early wakeup function module, and a custom function module.

According to an embodiment of the present disclosure, a clock management unit design method using a no-code approach executed using the no-code approach by at least one process in a computer system comprising a clock component storage in which clock component information constituting a clock management unit is stored and a hardware code logic storage in which a hardware code logic for generating a designed clock management unit as hardware code is stored includes: setting auto clock gating of the clock management unit, designing a new clock instance by setting values of a register field defining a function of the new clock instance based on previously generated clock instance information included in the clock management unit and the clock component information, activating a function module of the new clock instance based on whether the auto clock gating of the clock management unit is set and the setting values of the register field of the new clock instance, and generating hardware code for the activated function module, hardware code for a register module for operating the activated function module, hardware code for a port for connecting the register module and the activated function module, and hardware code for connection based on the setting values of the register field of the new clock instance, activated function module information of the new clock instance, and the hardware code logic.

In some embodiments, the method may further include activating an adapter function module of the new clock instance when the auto clock gating of the clock management unit is set.

In some embodiments, the connection may include a clock line and a handshake signal line.

In some embodiments, the method may further include: generating the new clock instance based on the previously generated clock instance information and the clock component information, determining a field value of a base register for setting a basic function of a clock source corresponding to the new clock instance, and determining a field value of an extension register for setting an extended function of the new clock instance.

In some embodiments, the method may further include: activating a basic function module for performing the basic function of the new clock instance, and when the field value of the extension register for setting the extended function of the new clock instance is set to a specific value, activating an extended function module for performing the extended function.

In some embodiments, the clock component information may include: a basic function module for performing a basic function and an extended function module for performing an extended function for each clock component, an address range allocated to each clock component, an alignment size of each clock component, a base register offset size of each clock component, an extension register offset size of each clock component, and configuration field information for each clock component.

In some embodiments, the configuration field information for each clock component may include a field name, a bit position, a bit size, an access permission, and an initial value.

In some embodiments, a start address of the register of the new clock instance may be determined as a value obtained by adding a start address and an alignment size of a register of the previously generated clock instance.

In some embodiments, the clock component may be one of a PLL controller component, a clock divider component, a clock multiplexer component, and a clock gate component.

In some embodiments, the clock component may be the clock divider component, the field of the extension register of the new clock instance may include at least one of a power down field, a throttle field, and a custom field, and the clock divider component may include at least one of an override function module, a throttle function module, and a custom function module,

In some embodiments, the clock component may be the clock multiplexer component, the field of the extension register of the new clock instance may include at least one of a throttle field and a custom field, and the clock multiplexer component may include at least one of a throttle function module and a custom function module,

In some embodiments, the clock component may be the clock gate component, the field of the extension register of the new clock instance may include at least one of a shortstop field, an early wakeup field, and a custom field, and the clock gate component may include at least one of a shortstop function module, an early wakeup function module, and a custom function module.

According to an embodiment of the present disclosure, a computer program stored in a computer-readable medium to execute the method on a computer is provided.

In various embodiments of the present disclosure, the connections between individual clock elements that constitute the clock management unit may be designed using a no-code approach, while considering the settings required in the clock design process of a system-on-chip (SoC).

In various embodiments of the present disclosure, the clock management unit and internal function modules of individual clock elements may be automatically derived, thereby effectively improving the efficiency of the design work.

In various embodiments of the present disclosure, a worker may design hardware code corresponding to the internal function modules of individual clock elements constituting the clock management unit and the connections between the individual clock elements using a no-code approach, without requiring coding knowledge or expertise in clock processes.

In various embodiments of the present disclosure, since the clock management unit may be designed considering the settings required throughout the clock design process, global optimization may be easily achieved.

The effects of the present disclosure are not limited to those mentioned above. Other effects not explicitly stated may be clearly understood by those skilled in the art from the description of the claims.

### BRIEF DESCRIPTION OF THE DRAWINGS

Embodiments of the present disclosure will be described with reference to the accompanying drawings, in which like reference numerals represent like elements, but are not limited thereto.

FIG. 1 is a block diagram illustrating a typical system-on-chip (SoC).

FIG. 2 is a detailed block diagram illustrating a clock management unit included in the SoC of FIG. 1.

FIG. 3 is a configuration diagram of a clock management unit design system using a no-code approach according to the present disclosure.

FIG. 4 is a diagram illustrating an example of a display screen of a clock management unit design system using a no-code approach according to the present disclosure.

FIG. 5 illustrates an example of address ranges of registers allocated to clock components.

FIG. 6 illustrates an example of the register address allocation for three clock divider instances.

FIG. 7 is a block diagram illustrating an internal function module of a clock multiplexer component according to the present disclosure.

FIG. 8 is a block diagram illustrating an internal function module of a clock divider component according to the present disclosure.

FIG. 9 is a block diagram illustrating an internal function module of a clock gate component according to the present disclosure.

FIG. 10 is an operational flow diagram illustrating a method for designing a clock management unit using a no-code approach according to the present disclosure.

FIG. 11 illustrates an exemplary computing device for performing the above-described method and/or embodiments.

### DETAILED DESCRIPTION OF EMBODIMENTS

Hereinafter, specific details for implementing the present disclosure will be described in detail with reference to the attached drawings. However, in the following description, a detailed description of known functions and configurations incorporated herein will be omitted when it may obscure the subject matter of the present disclosure.

The same reference numbers will be used in the drawings to refer to the same or like parts. In the description of embodiments below, redundant descriptions of identical or corresponding components may be omitted. However, even if the description of a component is omitted, it is not intended that such a component is not included in any embodiment.

The advantages and features of the embodiments disclosed in this specification, and methods for achieving the same will become clear with reference to the embodiments described below together with the attached drawings. However, the present disclosure is not limited to the embodiments disclosed below, but may be implemented in various different forms, and the embodiments are only provided to fully inform a person skilled in the art related to the present disclosure of the scope of the present disclosure.

The terms used in this specification will be briefly described, and the disclosed embodiments will be specifically described. The terms used in this specification are selected from the most widely used general terms in consideration of the functions in the present disclosure, but they may vary depending on the intention of engineers in the relevant field, precedents, or the emergence of new technologies, and in certain cases, there are terms arbitrarily selected by the applicant, and in this case, the meanings thereof will be described in detail in description of the relevant disclosure. Therefore, the terms used in this specification should be defined based on the meaning of the terms and the overall content of the present disclosure, not simply the names of the terms.

In this specification, singular expressions include plural expressions unless the context clearly specifies that they are singular. In addition, plural expressions include singular expressions unless the context clearly specifies that they are plural. When a part of the entire specification includes a certain component, this does not mean that other components are excluded, but that other components may be included, unless otherwise specifically stated.

In the present disclosure, the terms “comprise,” “comprising,” and the like may indicate the presence of features, steps, operations, elements, and/or components, but such terms do not exclude the addition of one or more other functions, steps, operations, elements, components, and/or combinations thereof.

In the present disclosure, when a specific component is referred to as being “coupled”, “combined”, “connected”, “associated”, or “reacted” with any other component, the specific component may be directly coupled, combined, connected, and/or associated or reacted with the other component, but is not limited thereto. For example, one or more intermediate components may exist between the specific component and the other component. In addition, “and/or” in the present disclosure may include each of one or more listed items or a combination of at least a part of one or more items.

In the present disclosure, the terms “first”, “second”, and the like are used to distinguish a specific component from other components, and the components described above are not limited by these terms. For example, a “first” component may be used to refer to an element having the same or similar form as a “second” component.

In various embodiments of the present disclosure, the term “clock components” may refer to clock tools that may be utilized in clock management unit design, and the clock components may include a PLL controller component, a clock divider component, a clock multiplexer component, a clock gate component, and others. In embodiments of the present disclosure, clock components may be displayed as icons in a clock component window, and each clock component may include a basic function module for performing basic functions for each clock component and an extended function module for performing extended functions for each clock component. Furthermore, each clock component may include address ranges allocated to each clock component, alignment size of individual clock components, a base register offset size for each clock component, an extension register offset size for each clock component, register field information (field name, bit position, bit size, access permission, initial value, etc.) for each clock component, and the like. The register field may include an extended function setting field.

In various embodiments of the present disclosure, the term “clock instance” may refer to a clock component added to a design window by user operation, and the clock instance may be a clock component included in a clock management unit design. When the user drags and drops an arbitrary clock component icon from a clock component window to a design window area, a clock instance corresponding to the clock component may be created. When a clock instance is created, a base register and, optionally, an extension register for the clock instance may be automatically generated, and the field values constituting the base register and the optionally generated extension register may be preset or modified by user input. In addition, the clock instance may include a basic function module and an extended function module. When any field value of the extension register of the clock instance is set to a preset value, the extended function module for performing the corresponding extended function may be activated.

The clock management unit may include multiple clock instances for each type of clock component. A clock instance generated based on a PLL controller component is referred to as a PLL controller instance, a clock instance generated based on a clock divider component is referred to as a clock divider instance, a clock instance generated based on a clock multiplexer component is referred to as a clock multiplexer instance, and a clock instance generated based on a clock gate component is referred to as a clock gate instance.

Each clock instance may include at least one basic function module and may optionally include at least one activated extended function module.

According to the present disclosure, when a clock instance is created, a basic function module and basic register field values may be automatically assigned. If the clock instance includes an extension register function, the clock instance may activate an extended function module for performing the extended function. In addition, a port for connecting the extension register field and the extended function module may be added. If the extended function module requires user input, a user input port may be further added to the corresponding clock instance. In addition, hardware code may be generated based on the configured base register field values, extension register field values, the basic function module and the extended function module of the clock instance.

In various embodiments of the present disclosure, “clock element” may refer to a hardware-coded module based on a designed clock instance, which may configure a clock management unit.

In summary, a clock component is a building block for designing a clock management unit, a clock instance is a node included in a clock management unit design, and a clock element is a module that is implemented as hardware code based on a designed clock instance and may operate within a clock management unit.

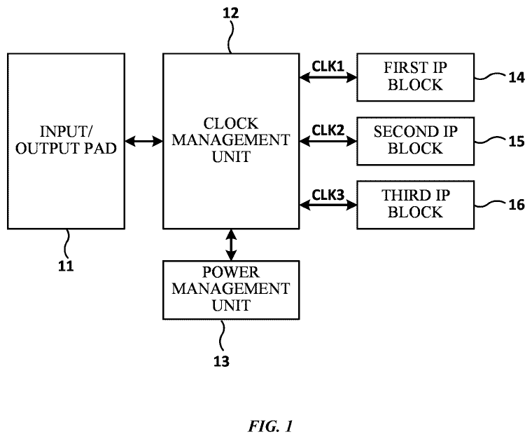

FIG. 1 is a block diagram illustrating a typical system on chip (SoC).

The SoC may include an input/output pad 11, a clock management unit (CMU) 12, a power management unit (PMU) 13, and one or more intellectual property (IP) blocks 14, 15, and 16. The clock management unit 12 may generate clock signals to be provided to the first through third IP blocks 14, 15, and 16. For example, the clock management unit 12 may generate first through third clock signals CLK1, CLK2, and CLK3. The clock management unit 12 may provide the first clock signal CLK1 to the first IP block 14, provide the second clock signal CLK2 to the second IP block 15, and provide the third clock signal CLK3 to the third IP block 16.

The first through third IP blocks 14, 15, and 16 are connected to a system bus and may communicate with each other through the system bus. Each of the first through third IP blocks 14, 15, and 16 may include a processor, a graphics processor, a memory controller, an input and output interface block, and others.

The power management unit 13 controls the power supplied to the first through third IP blocks 14 to 16. For example, when the SoC enters standby mode, the power management unit 13 may cut off the power provided to the first through third IP blocks 14 to 16, thereby reducing the power consumption of the SoC.

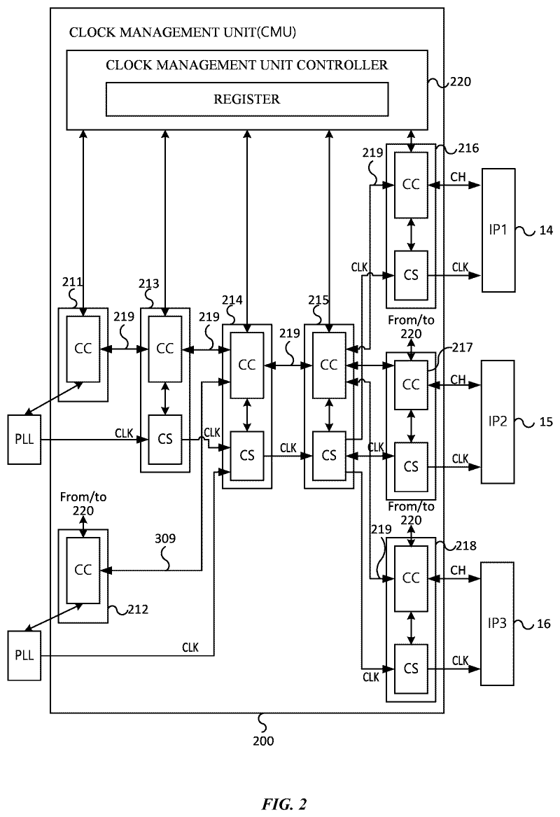

FIG. 2 is a detailed configuration block diagram of the clock management unit 12 and 200 included in the SoC of FIG. 1.

The clock management unit 200 may correspond to the clock management unit 12 of FIG. 1.

Referring to FIG. 2, the clock management unit 200 may include a plurality of clock elements 211, 212, 213, 214, 215, 216, 217, and 218 and a clock management unit CMU controller 220. The plurality of clock elements 211, 212, 213, 214, 215, 216, 217, and 218 generate clock signals CLK to be provided to the IP blocks 14, 15, and 16. The clock signals provided to the IP blocks 14, 15, and 16 may have different frequencies. The clock management unit controller 220 controls the clock elements 211, 212, 213, 214, 215, 216, 217, and 218 to ensure that a clock signal with the frequency required by the IP blocks 14, 15, and 16 is provided. The clock elements may include phase locked loop (PLL) controllers 211 and 212, clock dividers 213 and 215, a clock multiplexer 214, and clock gates 216, 217, and 218.

Each clock element may include a clock source CS and a clock control circuit CC that controls the clock source CS. The clock source CS may include, for example, a multiplexing circuit, a divider circuit, and a gating circuit. The PLL controllers 211 and 212 do not include a clock source and may control a PLL outside the clock management unit 200.

Each of the clock dividers 213 and 215 includes a devider circuit as a clock source CS, and the clock control circuit CC of each of the clock dividers 213 and 215 controls the devider circuit. The divider circuit divides an input clock signal and outputs it, and the clock control circuit CC may control the division ratio of the devider circuit. The clock multiplexer 214 includes a multiplexing circuit as a clock source CS, and the clock control circuit CC of the clock multiplexer 214 controls the multiplexing circuit. The multiplexing circuit selectively outputs one of multiple input clock signals, and the clock control circuit CC may control which input clock signal is selected and output by the multiplexing circuit.

Each of the clock gates 216, 217, and 218 includes a gating circuit as a clock source CS, and the clock control circuit CC of each clock gate 216, 217, and 218 controls the gating circuit. The gating circuit enables a clock signal applied to the IP block only when operation is required and blocks the clock signal otherwise, thereby preventing unnecessary clock signals, and such operation is called auto-clock gating. The clock control circuit CC may control the gating circuit to stop or enable a clock signal. The clock gates 216, 217, 218 and the IP blocks 14, 15, 16 are connected by a Q-channel, and the clock control circuit of the clock gates 216, 217, 218 determines whether the corresponding IP block 14, 15, 16 requires a clock signal through a Q-channel handshake with the IP block 14, 15, 16, enables a clock signal for the IP block 14, 15, 16 requiring the clock signal, and blocks the clock signal for the IP block that does not require the clock signal. Accordingly, it is possible to reduce power consumption without causing an error in operation of the IP block.

The clock element 211 is a parent of clock element 213, and clock element 213 is a child of clock element 211 and a parent of clock element 214. Clock element 214 is a child of two clock elements 212 and 213 and a parent of clock element 215. Clock element 215 is a child of clock element 214 and a parent of three clock elements 216, 217, and 218. Meanwhile, clock elements 211 and 212, which include a PLL controller, are root clock elements, and clock elements 216, 217, and 218, which are located close to the IP blocks 14, 15, and 16 and include gating circuits, are leaf clock elements.

Such a parent-child relationship may be established between clock control circuits CC and between clock sources CS according to the parent-child relationship between the clock elements 211, 212, 213, 214, 215, 216, 217, and 218. Connections may be included between clock elements, and the connections may include clock lines CLK connected between parent clock sources CS and child clock sources CS.

Conventionally, auto clock gating was implemented between the clock management unit and the IP blocks, but auto clock gating was not applied between the clock elements within the clock management unit. Accordingly, only clock lines CLK were connected between the clock sources CS. In this case, even when the clock gates 216, 217, 218 blocked the clock signal because the IP block did not require a clock signal, all other clock elements continued to operate, leading to a problem of continuous power consumption.

To solve this problem, a technology has been developed to enable auto clock gating between the clock elements within the clock management unit as well. For this purpose, the connection may further include a handshake signal line 219 connected between the parent clock control circuit CC and the child clock control circuit CC. The parent clock control circuit and the child clock control circuit communicate with each other via the handshake signal line 219, and the parent clock control circuit may determine whether the child clock control circuit needs a clock signal and control each clock source to supply a clock signal to the child clock control circuit or stop supplying the clock signal.

The clock element may include at least one function module, at least one port for connecting each function module to at least one of a register of the clock management unit controller 220 and a user input, a connection for connecting to the parent clock element and a connection for connecting to the child clock element. These connections may include a clock line and may optionally include a handshake signal line.

The clock management unit controller 220 includes a register, and information necessary to control and configure operation of each clock element of the clock management unit 200 may be recorded in the register as a register transfer level (RTL) code. In addition, the register transfer level (RTL) code describing operation of the clock control circuit of each clock element may be recorded in the register of the clock management unit controller 220, and the register transfer level (RTL) code for controlling the operation of the connection between each clock element may be recorded in the register of the clock management unit controller 220. This register transfer level (RTL) code may be implemented as actual clock management unit hardware using a hardware design tool. Each clock element may include at least one function module, and each of the at least one function module is written in hardware code and may be implemented as hardware by a hardware design tool.

In order to configure a clock management unit, hardware code for internal function modules of each clock element may be generated, and register transfer level (RTL) code for each clock element and register transfer level (RTL) code for connections between each clock element may be generated, and conventionally, developers manually generated hardware code using Verilog code based on clock diagram drawing results.

The present disclosure proposes a system and a method for designing a clock management unit using a no-code approach that allows configuration of connections between the clock elements and function modules of each clock element based on a graphical user interface (GUI), derives hardware code corresponding to the connections between the clock elements using a no-code approach based on the configured connections, and derives hardware code corresponding to the basic function modules and the extended function modules according to the basic function and the extended function of the clock elements.

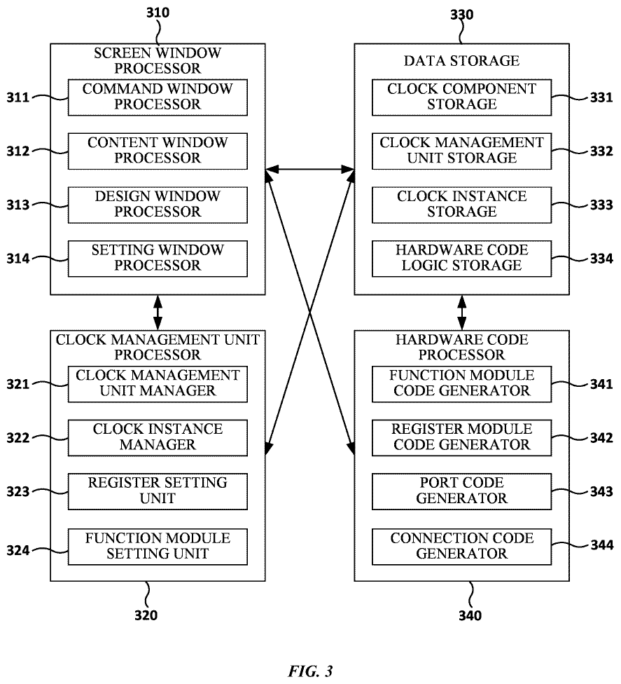

FIG. 3 is a configuration diagram of a clock management unit design system using a no-code approach according to the present disclosure. The clock management unit design system using a no-code approach according to the present disclosure may be implemented as a computer system.

The clock management unit design system using a no-code approach according to the present disclosure may include a screen window processor 310 that detects user input and outputs processing results in response to the user input on a display screen, a clock management unit processor 320 that generates at least one clock instance based on clock component information and generates a connection between any two clock instances to design the clock management unit, a data storage 330 that stores hardware code logic for generating hardware code based on the clock component information and the designed clock management unit information, and a hardware code processor 340 that generates hardware code corresponding to the designed clock management unit information using the hardware code logic.

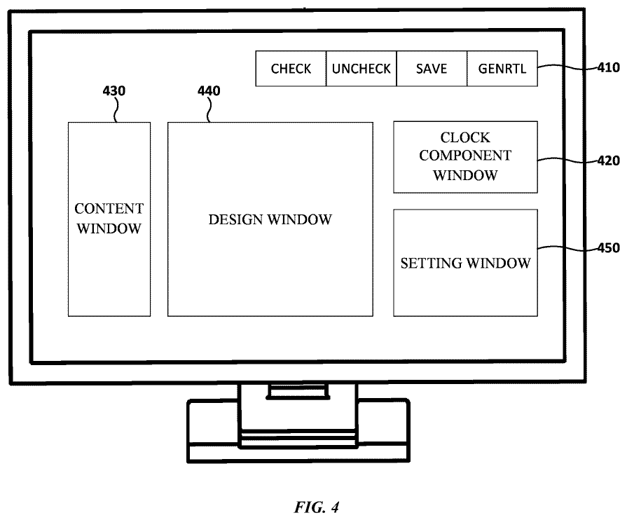

FIG. 4 is a diagram illustrating an example of a display screen of a clock management unit design system using a no-code approach according to the present disclosure.

The display screen of the clock management unit design system using a no-code approach according to the present disclosure may include a command window 410 for receiving user commands, a clock component window 420 displaying clock component icons, a content window 430 that provides an environment for adding, deleting, and modifying a list of clock management units under design and hierarchically displays a list of clock instances constituting each clock management unit under design along with basic function information and extended function information of each clock instance, a design window 440 that displays a clock diagram of the clock management unit under design and provides an environment for adding, deleting, and modifying clock instances constituting the clock management unit under design, and a setting window 450 that provides an auto clock gating setting environment for the clock management unit under design and an extended function setting environment for the clock instance selected in the design window 440. Herein, auto clock gating of the clock management unit may refer to an auto clock gating function between clock instances constituting the clock management unit. When auto clock gating is set for a clock management unit, auto clock gating may be used for all connections between clock instances constituting the clock management unit.

The command window 410 may include a CHECK button for receiving a check command to detect errors in the clock diagram of the clock management unit under design, the setting values of clock instances constituting the clock management unit under design, and the connections between parent and child clock instances; an UNCHECK button for receiving a command to deactivate a check result; a SAVE button for receiving a save command for the clock diagram displayed in the design window 440; and a GENRTL button for receiving a hardware code generation command for the clock diagram displayed in the design window 440.

The clock component window 420 may display icons representing a list of clock components that can be utilized in the design of the clock management unit. Clock components include a PLL controller component, a clock divider component, a clock multiplexer component, and a clock gate component, and the clock component window 420 may further display a label component. Here, a label component is a component that may be inserted into the input and output between any two clock components for partial design work when designing a complex clock diagram. When hardware code is generated, the label component may be ignored, and the two clock components may be coded to be directly connected.

The content window 430 may display a list of clock management units under design and provide an environment for adding, deleting, and modifying clock management units under design. In addition, under each clock management unit list, the content window 430 may display a list of clock instances constituting the corresponding clock management unit under design, hierarchically display the base register information of each clock instance, and optionally display extension register information of each clock instance.

The design window 440 may display a clock diagram of the clock management unit under design and provide an environment for adding, deleting, and modifying clock instances that constitute the clock management unit under design. When the user drags and drops any clock component from the clock component window 420 to the design window 440, a clock instance corresponding to the corresponding clock component may be created in the clock management unit under design. When a clock instance is created, a new clock instance list and the base register information of the new clock instance may be hierarchically added to the content window 430. Optionally, the extension register information of the new clock instance may also be added.

The settting window 450 may provide an environment for setting auto clock gating (ACG) of the clock management unit under design, and provide a function setting environment for the clock instance selected in the design window 440. When auto clock gating of the clock management unit under design is activated, auto clock gating may be applied to all connectors between any two clock instances constituting the clock management unit during the design. If auto clock gating is not applied between any two clock instances, only a clock line is connected to the two clock instances, and if auto clock gating is applied between any two clock instances, a clock line and a handshake signal line are connected to the two clock instances.

### Screen Window Processor 310

The screen window processor 310 may include a command window processor 311 that displays buttons for receiving user commands on the command window 410, detects inputs from each button on the command window 410, and performs an operation corresponding to the input button; a content window processor 312 that hierarchically displays a list of clock management units under design, along with a list of clock instances and register information included in each clock management unit under design, on the content window 430, detects user input in the content window 430, and performs an operation corresponding to the user input; a design window processor 313 that displays the clock diagram of a clock management unit under design selected by the user on the design window 440, detects user input in the design window 440, and performs an operation corresponding to the user input; and a setting window processor 314 that displays the configuration information of the auto clock gating setting information of the clock management unit under design selected by the user and the configuration information of the clock instance selected by the user on the setting window 450, detects user input in the setting window 450, and performs an operation corresponding to the user input.

When the CHECK button is selected, the command window processor 311 may perform a check operation to detect errors in the clock diagram of the clock management unit under design, the setting values of the clock instances constituting the clock management unit under design, and the connections between parent and child clock instances, and highlights the parts where errors have occurred. When the UNCHECK button is selected, the command window processor 311 may restore the error indications in the clock diagram of the clock management unit under design to their original state and updates the display accordingly. When the SAVE button is selected, the command window processor 311 saves the design details of the clock management unit under design displayed in the design window 440 to the content data storage 330. When the GENRTL button is selected, the command window processor 311 generates hardware code for the clock diagram of the clock management unit under design displayed in the design window 440.

The content window processor 312 may provide an environment for adding, deleting, and modifying a list of clock management units under design and a list of clock instances included in each clock management unit under design. The content window processor 312 may hierarchically display a clock instance list under each clock management unit under design, along with the base register information corresponding to the basic function of each clock instance and, optionally, the extension register information based on the extended function. The user may add, delete, or rename a clock management unit under design in the content window 430, and in response to user input, the list of clock management units under design may be added, deleted, or changed in a clock management unit storage 332, and auto clock gating of each clock management unit may be set. When the user renames a clock management unit under design, the content window processor 312 may ensure that not only the name of the clock management unit under design but also the names of its clock instances, as well as the base register names and extension register names of the clock instances, are changed simultaneously.

The design window processor 313 may ensure that the clock diagram of the clock management unit under design is displayed in the design window 440 and provide an environment for adding, deleting, and modifying clock instances that constitute the clock management unit under design. When the user adds an arbitrary clock component from the clock component window 420 to the design window 440, the design window processor 313 detects this action and initiates the clock instance addition process.

The setting window processor 314 may ensure that the configuration information of auto clock gating (ACG) of the clock management unit under design is displayed, and detect user input in the setting window 450 such that operation corresponding to the user input may be performed. That is, the auto clock gating of the clock management unit under design may be set or de-set according to the user's input. In addition, the setting window processor 314 ensures that the configuration information of the extended function of the clock instance selected by the user is displayed on the setting window 450, and detects user input in the setting window 450 such that an operation corresponding to the user input may be performed. The setting window processor 314 may enable or disable the extended function of the clock instance according to the user's input.

### Data Storage 330

The data storage 330 may include a clock component storage 331 that stores clock component information, a clock management unit storage 332 that stores the configuration information of auto clock gating (ACG) of the clock management unit under design, a list of clock instances included in the clock management unit under design, and a list of registers corresponding to the clock instances, a clock instance storage 333 that stores basic function information and extended function information of each clock instance included in the clock management unit under design and register information of individual clock instances, and a hardware code logic storage 334 that stores hardware code logic for generating hardware code based on the configuration information of auto clock gating of the clock management unit under design, the basic function information and the extended function information of the designed clock instance, and the register information. The list of registers corresponding to clock instances may include a base register list and an extension register list.

The clock component information stored in the clock component storage 331 may include the register address range allocated to each clock component, the alignment size of each clock component, the base register offset size for each clock component, the extension register offset size for each clock component, and configuration field information (field name, bit position, bit size, access permission, initial value, etc.) for each clock component. The clock component information defines the register address and field values of a clock instance generated based on the corresponding clock component. The maximum number of clock instances for each clock component may be calculated using the register address range allocated to each clock component and its alignment size. Clock components may include a PLL controller component, a clock divider component, a clock multiplexer component, and a clock gate component. The clock components may include a basic function module for performing a basic function of the clock component and an extended function module for performing an extended function of the clock component. When a clock instance corresponding to a clock component is created, the basic function module is enabled, and when the user sets an extended function of the clock instance in the setting window 450, the extended function module corresponding to the set extended function may be enabled. The basic function module and the extended function module may vary for each clock component.

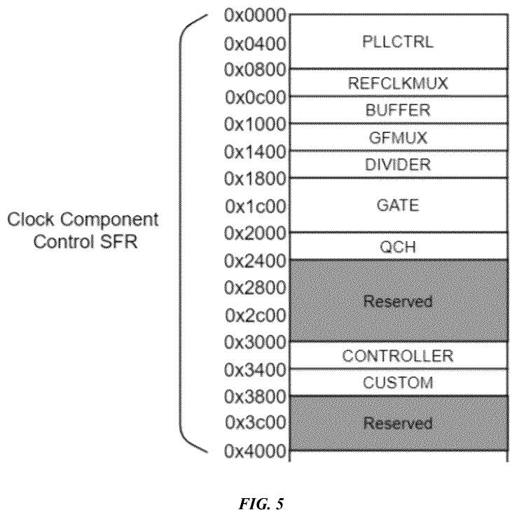

FIG. 5 illustrates an example of register address ranges allocated to clock components. For example, an address range of 0×0000 to 0×0800 may be allocated to the PLL controller component, an address range of 0×1400 to 0×1800 may be allocated to the clock divider component, an address range of 0×1000 to 0×1400 may be allocated to the clock multiplexer component, and an address range of 0×1800 to 0×2000 may be allocated to the clock gate component. The clock management unit may include multiple clock instances for each type of clock component. For example, it may include three clock divider instances.

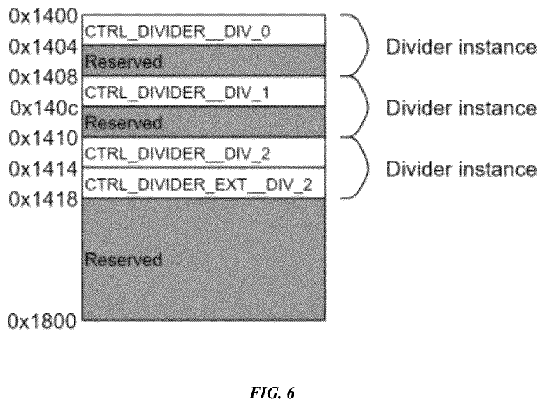

FIG. 6 illustrates an example of register address allocation for three clock divider instances.

The addresses of the three clock divider instances are allocated within the address range 0×1400 to 0×1800 assigned to each clock component. The register address of the first clock divider instance DIV_0 may be allocated as the start address 0×1400 of the address range assigned to the clock divider component. The register address of the second clock divider instance DIV_1 may be 0×1408, obtained by adding the start address of the first clock divider instance and its alignment size 0×8. The register address of the third clock divider instance may be 0×1414, obtained by adding the start address of the second clock divider instance and its alignment size. The first and second clock divider instances include only base registers, while the third clock divider instance may include both a base register and an extension register. Base register setting values of the clock divider instances are written from the clock divider instance start addresses up to the base register offset sizes, and extension register setting values are written to the remaining space.

The clock component storage 331 stores configuration field information (field name, bit position, bit size, access permission, initial value, etc.) for each individual clock component. This configuration field information may vary depending on the type of each clock component. Here, the bit position refers to the start address of the corresponding field among the addresses allocated to an individual clock instance, the bit size indicates the range of the field, the access permission specifies whether write access is allowed (read-only or read-write), and the initial value represents the initial setting value.

The PLL controller component may include a SELECT field, a BUSY field, and a DEBUG (DBG_INFO) field as base register information and may include a POWER-DOWN (PWRDOWN) field and a CUSTOM field as extension register information. The field name, bit position, bit size, access permission, and initial value of each field may be configured. Here, the SELECT field is used to select a PLL type, the BUSY field is used to monitor whether the clock element is operating, and the DEBUG field stores debugging information. The PLL controller component may further include an auto clock gating field that is enabled when auto clock gating of the clock management unit is set.

The clock multiplexer component includes a SELECT field, a BUSY field, and a DEBUG (DBG_INFO) field as base register information and may include a THROTTLE field and a CUSTOM field as extension register information. The field name, bit position, bit size, access permission, and initial value of each field are configured. Here, the SELECT field is used to select the number of multiplexer inputs, the BUSY field is used to monitor whether the clock element is operating, and the DEBUG field stores debugging information. The clock multiplexer component may further include an auto clock gating field that is enabled when auto clock gating of the clock management unit is set.

The clock divider component includes a division ratio (DIVRATIO) field, a BUSY field, and a DEBUG (DBG_INFO) field as base register information and may include a POWER-DOWN (PWRDOWN) field, a THROTTLE field, and a CUSTOM field as extension register information. The field name, bit position, bit size, access permission, and initial value of each field are configured. The division ratio field is used to set the division ratio of the clock divider, the BUSY field is used to monitor whether the clock element is operating, and the DEBUG field stores debugging information. The clock divider component may further include an auto clock gating field that is enabled when auto clock gating of the clock management unit is set.

The clock gate component may include a BUSY field and a DEBUG (DBG_INFO) field as base register information and may include an ENABLE field, a SHORTSTOP field, an EARLY WAKEUP (EWAKEUP) field, and a CUSTOM field as extension register information. The field name, bit position, bit size, access permission, and initial value of each field are configured. The BUSY field is used to monitor whether the clock element is operating, and the DEBUG field stores debugging information. The clock gate component may further include an auto clock gating field that is enabled when auto clock gating of the clock management unit is set.

The POWER-DOWN (PWRDOWN) field determines whether to use a function that controls the relevant clock element while the power up/down sequence of any power domain is in operation. The PLL controller instance and the clock multiplexer instance support an operational feature that forces the output value to be overridden to 0 if the POWER-DOWN field is set to a specific value, while the clock divider instance supports an operation that forces the output value to a low level if the POWER-DOWN field is set to a specific value.

The THROTTLE field determines whether to lower the clock frequency momentarily to reduce temperature when the clock element's temperature exceeds a certain threshold. The clock multiplexer instance and the clock divider instance support an operation that forces the division ratio and output frequency to change when a throttle signal is input if the THROTTLE field is set to a specific value.

The CUSTOM field determines whether to control the relevant clock element through separate custom hardware. The SHORTSTOP field supports an operation that stops several cycles before and after a transition where a signal changes from 0 to 1 or from 1 to 0. The SHORTSTOP field may be set in the clock gate instance. The EWAKEUP field receives a signal from outside the clock management unit to determine whether to enable auto clock gating between the clock element and the IP block.

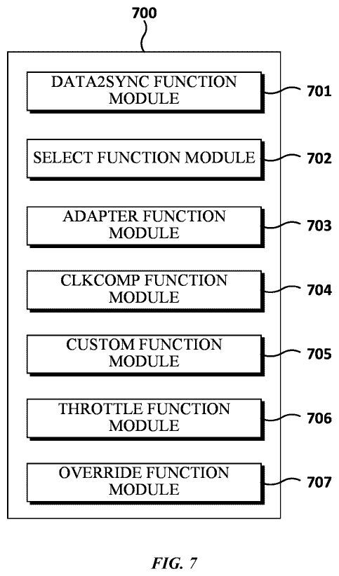

FIG. 7 is a block diagram illustrating an internal function module of a clock multiplexer component according to the present disclosure. The clock multiplexer component 700 may include a DATA-TO-SYNC (DATA2SYNC) function module 701, a SELECT function module 702, an ADAPTER function module 703, and a CLOCK COMPARISON (CLKCOMP) function module 704 as the basic function module. The clock multiplexer component 700 may include a CUSTOM function module 705, a THROTTLE function module 706, and an OVERRIDE function module 707 as the extended function module.

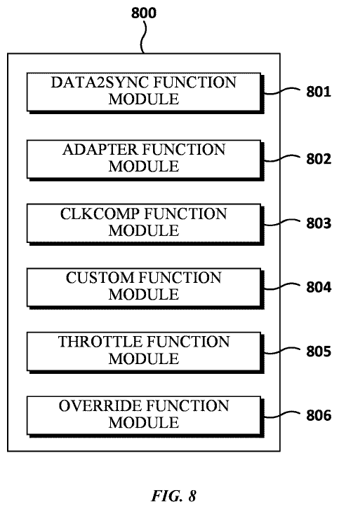

FIG. 8 is a block diagram illustrating an internal function module of a clock divider component according to the present disclosure. The clock divider component 800 may include a DATA2SYNC function module 801, an ADAPTER function module 802, and a CLKCOMP function module 803 as the basic function module. The clock divider component 800 may include a CUSTOM function module 804, a THROTTLE function module 805, and an OVERRIDE function module 806 as the extended function module.

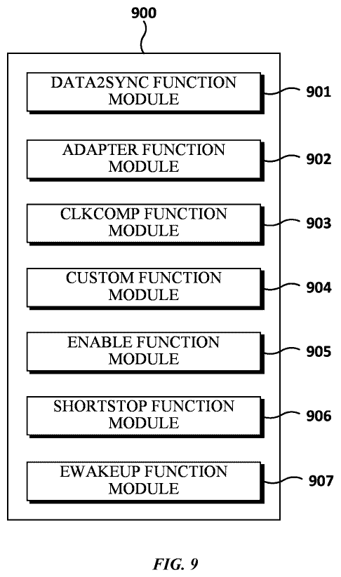

FIG. 9 is a block diagram illustrating an internal function module of a clock gate component according to the present disclosure. The clock gate component 900 may include a DATA2SYNC function module 901, an ADAPTER function module 902, and a CLKCOMP function module 903 as the basic function module. The clock gate component 900 may include a CUSTOM function module 904, an ENABLE function module 905, a SHORTSTOP function module 906, and an EARLY WAKEUP (EWAKEUP) function module 907 as the extended function module.

The DATA2SYNC function modules 701, 801, 901 are a module that may perform a function of synchronizing a control signal of a clock control circuit of a clock element and a clock signal of a clock source, and the CLKCOMP function modules 704, 803, 903 are a module that may processe a clock signal received from a parent clock source and then transmits it to a child clock source. The ADAPTER function modules 703, 802, 902 are a module that may be activated when auto clock gating of the clock management unit is set, and perform a function of operating a handshake signal line connected to a parent clock control circuit and operating a handshake signal line connected to a child clock control circuit.

The SELECT function module 702 is a module that may perform a function of selecting the number of multiplexer inputs according to a setting value of the SELECT field, and the CUSTOM function modules 705, 804, 904 are a module that may be activated according to a setting value of the CUSTOM field and perform a function of controlling the corresponding clock element through separate custom hardware. The THROTTLE function modules 706, 805 are a module that may be activated according to a setting value of the THROTTLE field and perform a function of momentarily lowering a clock frequency when a temperature of the clock element rises above a certain level. In addition, the OVERRIDE function modules 707, 806 are a module that may be activated according to a setting value of the POWER-DOWN field and performs a function of forcibly setting an output value to 0. The SHORTSTOP function module 906 is a module that may be activated according to a setting value of the SHORTSTOP field and perform a function of stopping several cycles before and after a section where a signal changes from 0 to 1 or from 1 to 0, and the EARLYWAKEUP function module 907 is a module that may be activated according to a setting value of the EARLY WAKEUP field and perform a function of receiving a signal from outside the clock management unit to perform an auto clock gating function with the IP block.

The clock management unit storage 332 may store the configuration information of auto clock gating (ACG) of the clock management unit under design, a list of clock instances included in the clock management unit under design, and a list of registers corresponding to the clock instances.

The clock instance storage 333 may store clock instance information, extended function information, register information and the like for each clock instance included in a clock management unit under design. The clock instance storage 333 may store the name of the clock management unit under design, the type of clock component of each clock instance, the start address of the corresponding clock instance, the basic function module of the clock instance and the adapter function module activated in response to the auto clock gating settings, the extended function module activated in response to the extended function of the corresponding clock instance set by the user, and the setting values of each register field. The setting values of each register field may be configured based on clock component information or may be adjusted according to user input. In addition, port information for connecting the register to the basic function module and the extended function module for the clock instance, and handshake signal line information and clock line information for connecting the adapter function module to the parent clock instance and the child clock instance may be further stored.

The hardware code logic storage 334 may store hardware code logic for generating hardware code based on the designed clock management unit information, the auto clock gating setting information of the clock management unit, and the clock instance information and register information.

### Clock Management Unit Processor 320

The clock management unit processor 320 may include a clock management unit manager 321 that generates a clock management unit and stores configuration information of auto clock gating of the clock management unit in the clock management unit storage 332, a clock instance manager 322 that generates a new clock instance based on information on a previously generated clock instance of the same clock component type and clock component information and stores it in the clock instance storage 333, a register setting unit 323 that sets field values of a base register that define the basic function of the new clock instance and field values of an extension register that define the extended function of the new clock instance and stores them in the clock instance storage 333, and a function module setting unit 324 that activates a basic function module for performing the basic function of the new clock instance, an extension function module for performing the extended function of the new clock instance, and an adapter function module based on the auto clock gating setting of the clock management unit.

The clock management unit manager 321 allows the user to generate a new clock management unit by manipulating the content window 430 and store it in the clock management unit storage 332, or loads the previously generated clock management unit under design displayed in the content window 430 from the clock management unit storage 332 for modification. When a new clock management unit or a clock management unit under design is selected, an auto clock gating setting screen for the corresponding clock management unit may be displayed in the setting window 450, and auto clock gating setting values according to the manipulation of the user may be stored in the clock management unit storage 332. Furthermore, when a clock management unit is selected, a clock diagram for the corresponding clock management unit may be displayed in the design window 440, allowing modification of the clock diagram of the clock management unit. That is, the clock instance may be added, delected or modified in the clock management unit.

The clock instance management unit 322 may be executed to generate a new clock instance when the user adds any clock component from the clock component window 420 to the design window 440. The name of the new clock instance may include the name of the clock management unit under design that contains the new clock instance and information on the clock component type of the new clock instance. In addition, the address of the new clock instance may be set based on information from a previously generated clock instance of the same clock component type and clock component information. That is, the start address of the register of the new clock instance may be determined by adding the start address of the register of the previously generated clock instance to the alignment size of the clock component information, and the initial setting value of the register field may be determined based on the base register offset size, extension register offset size, and configuration field information of the clock component.

The register setting unit 323 may display the field name, bit position, bit size, access permission, and initial values of the configuration fields included in the base register of the clock instance on the design window 440 or the setting window 450 and may modify them according to user input. The base register configures the essential functions of the clock source of the clock element. That is, for the PLL controller instance, functions such as PLL type selection, clock element operation monitoring, and debugging may be set, and the corresponding register field values may be configured. For the clock multiplexer instance, functions such as multiplexer input selection, clock element operation monitoring, and debugging may be set, and the corresponding register field values may be configured. For the clock divider instance, functions such as division ratio configuration, clock element operation monitoring, and debugging may be set, and the corresponding register field values may be configured. For the clock gate instance, functions such as clock element operation monitoring, and debugging may be set, and the corresponding register values may be configured.

The register setting unit 323 may display extended functions that may be configured for each clock component on the screen. When the user selects an extended function, the corresponding field of the extension register corresponding to the extended function may be set. For the PLL controller instance, the POWER-DOWN (PWRDOWN) function, the CUSTOM function, and the like may be selected, and the values of the extension register field corresponding to the selected extended function may be configured. For the clock multiplexer instance, the THROTTLE function, the CUSTOM function and the like may be selected, and the values of the extension register field corresponding to the extended function selected by the user may be set. For the clock divider instance, the POWER-DOWN (PWRDOWN) function, the THROTTLE function, the CUSTOM function, and the like may be selected, and the values of the extension register field corresponding to the extended function selectetd by the user may be set. For the clock gate instance, the SHORTSTOP function, the ENABLE function, the EARLY WAKEUP (EWAKEUP) function, the CUSTOM function, and the like may be selected, and the values of the extension register field corresponding to the extended function selected by the user may be set.

The function module setting unit 324 may set, for each clock instance, the basic function module to be activated and the extended function module for performing the extended function set in the register setting unit 323 to be activated. That is, the clock component may include a basic function module for performing the basic function of the clock component and an extended function module corresponding to each of all extended functions that may be configured in the clock component, and accordingly, a clock instance generated based on the clock component may also include both the basic function module and the extended function module. However, the corresponding extended function module may be activated or deactivated depending on the user's extended function setting value.

Furthermore, the clock component may include an adapter function module for performing auto clock gating, and a clock instance generated based on the clock component may also include an adapter function module. However, depending on whether the auto clock gating of the clock management unit is set, the adapter function module of each clock instance may be activated or deactivated. The function module setting unit 324 may enable the adapter function module when auto clock gating of the clock management unit is set in the clock management unit manager 321.

### Hardware Code Processor 340

The hardware code processor 340 may include a function module code generator 341 that generates hardware code corresponding to the function module of the clock element based on the designed clock instance information, a register module code generator 342 that generates hardware code of the register module for driving the function module of the clock element, a port code generator 343 that generates hardware code of the port connecting the function module of the clock element and the register module, and a connection code generator 344 that generates hardware code of a connection between the clock element and at least one of the parent clock element and the child clock element.

The hardware code processor 340 may be executed when the GENRTL button in the command window 410 is selected. The user can select and execute the GENRTL button while a clock diagram of a clock management unit under design is displayed in the design window 440. Before executing the GENRTL button, the user can also verify in advance whether there are any errors in the clock diagram by executing the CHECK button.

The function module code generator 341 converts designed clock instance information in accordance with the hardware code logic stored in the hardware code logic storage 334 to generate hardware code of the function module. The basic function module may be mandatorily activated for each clock instance, the extended function module may be further activated according to the settings of the extended function of the clock instance, and hardware code may be generated for the basic function module and extended function module that are activated.

The register module code generator 342 may generate hardware code of the register module according to the hardware code logic based on the register field values of the designed clock instance. The hardware code for the register module that controls operation of the corresponding basic and extended function modules may be generated for each activated basic and extended function module of the clock element.

The port code generator 343 may generate hardware code of a port for connecting the basic function module and the extended function module that are activated to the corresponding register module, respectively. The port code generator 343 may generate hardware code for a port for communication between the activated extended function module and the register module, and may not generate hardware code for a port for communication between a deactivated extended function module and the register module. For example, a clock divider module may include a division ratio port, a busy port, and a debug port, and the corresponding division ratio port, busy port, and debug port may be generated for the register module related to the clock divider module.

The connection code generator 344 may generate hardware code for a clock line of the clock element. The clock line of the clock element may be connected to the parent clock element or may be connected to the child clock element. In addition, the connection code generator 344 may further generate hardware code of a handshake signal line of the clock element. The handshake signal line of the clock element may be connected to the parent clock element or may be connected to the child clock element.

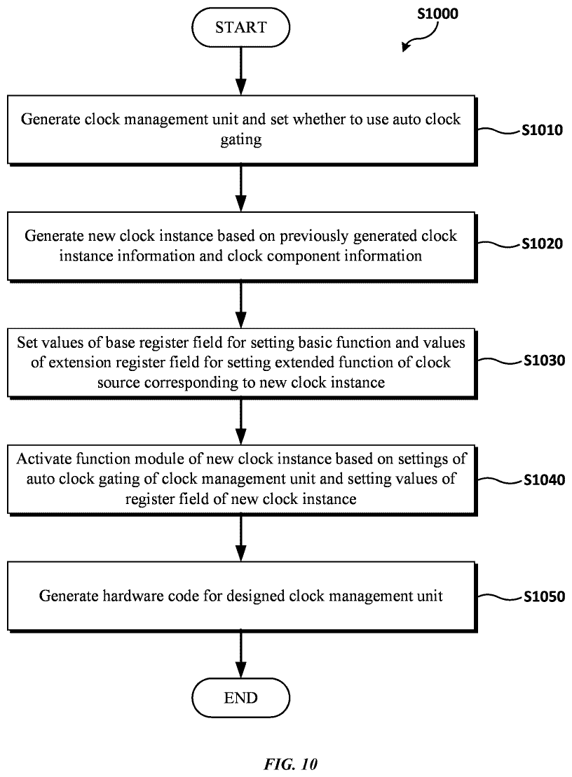

FIG. 10 is an operational flow diagram illustrating a method for designing a clock management unit using a no-code approach according to the present disclosure. The method for designing a clock management unit using a no-code approach according to the present disclosure may be executed by a processor of a computer system.

The computer system includes a clock component storage that stores clock component information for defining the register addresses and field values of clock instances generated based on clock components, and a hardware code logic storage that stores hardware code logic for generating a designed clock management unit as hardware code.

The processor generates a clock management unit and sets whether to perform auto clock gating of the clock management unit (S1001). The processor stores generated clock management unit information in the clock management unit storage 332.

The processor designs a new clock instance by setting the field values of registers that define the functions of the new clock instance based on information from previously generated clock instances and the clock component information.

The process of designing a new clock instance by the processor is described in detail. The processor may generate a new clock instance based on information from previously generated clock instances and the clock component information and stores it in the clock instance storage (S1020), and set values of the base register field for setting the basic function of the clock source corresponding to the new clock instance and values of the register field for setting the extended function of the new clock instance to store the values in the clock instance storage (S1030).

The processor may activate the function module of the new clock instance based on whether auto clock gating of the clock management unit is set and the setting value of the register field of the new clock instance (S1040). That is, the processor may activate the basic function module for performing the basic function of the new clock instance and, when the field value of the extension register for setting the extended function of the new clock instance is set to a specific value, activate the extended function module for performing the corresponding extended function. In addition, when auto clock gating of the clock management unit is set, the adapter function module for performing the auto clock gating is activated.

The processor may generate hardware code for the clock management unit designed based on the setting value of the register field of the new clock instance, the activated function module information of the new clock instance and the hardware code logic (S1050). That is, hardware code for the activated function module, hardware code for the register module for operating the activated function module, hardware code for the port for connecting the register module and the activated function module, and hardware code for connection may be generated.

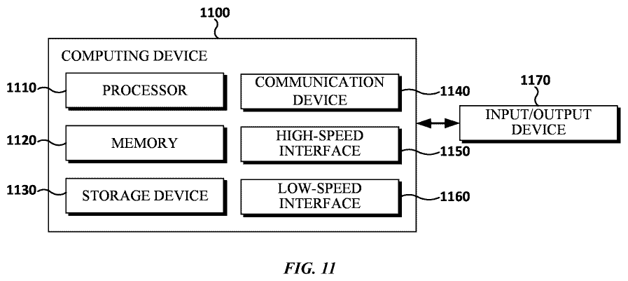

FIG. 11 illustrates an exemplary computing device 1100 for performing the methods and/or embodiments described above. According to one embodiment, the computing device 1100 may be implemented using hardware and/or software configured to interact with a user. Here, the computing device 1100 may include, but is not limited to, a laptop, a desktop, a workstation, a personal digital assistant, a server, a blade server, a mainframe, and the like. The components of the computing device 1100, their connections, and their functions are intended to be exemplary and are not intended to limit the implementations of the present disclosure described and/or claimed herein.

The computing device 1100 includes a processor 1110, a memory 1120, a storage device 1130, a communication device 1140, a high-speed interface 1150 connected to the memory 1120 and a high-speed expansion port, and a low-speed interface 1160 connected to a low-speed bus and the storage device. The components 1110, 1120, 1130, 1140, 1150, and 1160 may be interconnected using various buses and may be mounted on the same mainboard or connected in another suitable manner. The processor 1110 may be configured to process instructions of a computer program by performing basic arithmetic, logic, and input/output operations. For example, the processor 1110 may process instructions stored in the memory 1120 and the storage device 1130 and/or instructions executed within the computing device 1100 to display graphical information on an external input/output device 1170, such as a display device connected to the high-speed interface 1150.

The communication device 1140 may provide a configuration or function that enables the input/output device 1170 and the computing device 1100 to communicate with each other through a network and may also provide a configuration or function that supports communication between the input/output device 1170 and/or the computing device 1100 and other external devices. For example, a request or data generated by the processor of an external device according to a given program code may be transmitted to the computing device 1100 through a network under the control of the communication device 1140. Conversely, a control signal or command issued under the control of the processor 1110 of the computing device 1100 may be transmitted to another external device through the communication device 1140 and the network.

Although the computing device 1100 is illustrated in FIG. 11 as including a single processor 1110, a single memory 1120, and the like, the present disclosure is not limited thereto, and the computing device 1100 may be implemented using multiple memories, multiple processors, and/or multiple buses. Additionally, although FIG. 11 describes a single computing device 1100, the present disclosure is not limited thereto, and multiple computing devices may interact and perform the operations necessary to execute the described method.

The memory 1120 may store information within the computing device 1100. In one embodiment, the memory 1120 may be configured as a volatile memory unit or multiple memory units. Additionally or alternatively, the memory 1120 may be configured as a non-volatile memory unit or multiple memory units. Furthermore, the memory 1120 may be configured as a different type of computer-readable medium, such as a magnetic disk or an optical disk. Additionally, the memory 1120 may store an operating system and at least one program code and/or instruction.

The storage device 1130 may be one or more mass storage devices for storing data for the computing device 1100. For example, the storage device 1130 may be a computer-readable medium that includes a magnetic disk such as a hard disk or a removable disk, an optical disk, a semiconductor memory device such as an erasable programmable read-only memory (EPROM), an electrically erasable PROM (EEPROM), or a flash memory device, as well as a CD-ROM and a DVD-ROM disk, or may be configured to include such a computer-readable medium. Additionally, a computer program may be physically implemented in such a computer-readable medium.

The high-speed interface 1150 and the low-speed interface 1160 may serve as means for interacting with the input/output device 1170. For example, an input device may include devices such as a camera with an audio sensor and/or an image sensor, a keyboard, a microphone, and a mouse, while an output device may include devices such as a display, a speaker, and a haptic feedback device. In another example, the high-speed interface 1150 and the low-speed interface 1160 may serve as means for interfacing with a device that integrates both input and output functions, such as a touchscreen.

In one embodiment, the high-speed interface 1150 may manage bandwidth-intensive operations for the computing device 1100, whereas the low-speed interface 1160 may manage operations that are less bandwidth-intensive than those of the high-speed interface 1150, but such a functional allocation is merely exemplary. In one embodiment, the high-speed interface 1150 may be connected to the memory 1120, the input/output devices 1170, and high-speed expansion ports that accommodate various expansion cards (not shown). Additionally, the low-speed interface 1160 may be connected to the storage device 1130 and a low-speed expansion port. Furthermore, the low-speed expansion port, which may include various communication ports (e.g., USB, Bluetooth, Ethernet, and wireless Ethernet), may be connected to one or more input/output devices 1170, such as a keyboard, a pointing device, or a scanner, or to networking devices such as a router or a switch via a network adapter.

The computing device 1100 may be implemented in multiple different forms. For example, it may be implemented as a standard server or as a group of such standard servers. Additionally or alternatively, the computing device 1100 may be implemented as part of a rack server system or as a personal computer, such as a laptop. In this case, components of the computing device 1100 may be integrated with other components within any mobile device (not shown). The computing device 1100 may include one or more other computing devices or may be configured to communicate with one or more other computing devices.

Although the input/output device 1170 is illustrated in FIG. 11 as not being included in the computing device 1100, this is not limiting, and the input/output device 1170 may be configured as a single integrated device with the computing device 1100. Additionally, although the high-speed interface 1150 and/or the low-speed interface 1160 are illustrated in FIG. 11 as components separate from the processor 1110, this is not limiting, and they may be configured to be included in the processor 1110.

The above-described method and/or various embodiments may be realized by digital electronic circuits, computer hardware, firmware, software, and/or a combination thereof. Various embodiments of the present disclosure may be implemented by a data processing device, for example, one or more programmable processors and/or one or more computing devices, or as a computer-readable medium and/or a computer program stored on a computer-readable medium. The computer program described above may be written in any programming language, including compiled or interpreted languages, and may be distributed in any form, such as a standalone program, a module, or a subroutine. The computer program may be distributed through a single computing device, a plurality of computing devices connected through the same network, and/or a plurality of computing devices distributed to be connected through a plurality of different networks.

The above-described method and/or various embodiments may be performed by one or more processors configured to execute one or more computer programs that process, store and/or manage any function and the like by operating based on input data or generating output data. For example, the method and/or various embodiments of the present disclosure may be performed by a special purpose logic circuit such as a field programmable gate array (FPGA) or an application specific integrated circuit (ASIC), and a device and/or a system for performing the method and/or embodiments of the present disclosure may be implemented as special purpose logic circuits such as an FPGA or an ASIC.

The one or more processors executing a computer program may include one or more processors of a general purpose or special purpose microprocessor and/or any kind of digital computing device. The processor may receive instructions and/or data from each of a read-only memory and a random access memory, or may receive instructions and/or data from the read-only memory and the random access memory. In the present disclosure, components of a computing device performing the method and/or embodiments may include one or more processors for executing instructions, and one or more memories for storing instructions and/or data.

In one embodiment, the computing device may transmit/receive data to/from one or more mass storage devices for storing data. For example, the computing device may receive data from a magnetic disc or an optical disc and/or transmit data to the magnetic disc or the optical disc. A computer-readable medium suitable for storing instructions and/or data associated with a computer program may include, but is not limited to, any form of non-volatile memory, including semiconductor memory devices such as an erasable programmable read-only memory (EPROM), an electrically erasable PROM (EEPROM), and a flash memory device. For example, the computer-readable medium may include a magnetic disc, such as an internal hard disk or a removable disk, a photomagnetic disc, a CD-ROM, and a DVD-ROM disk.

To provide interaction with a user, the computing device may include, but is not limited to, a display device (e.g., a cathode ray tube (CRT), a liquid crystal display (LCD), or the like) for providing or displaying information to the user, and a pointing device (e.g., a keyboard, a mouse, a trackball, or the like) for enabling the user to provide input and/or commands to the computing device. That is, the computing device may further include any other types of devices for providing interaction with the user. For example, the computing device may provide any form of sensory feedback to the user, including visual feedback, auditory feedback, and/or tactile feedback, for interacting with the user. In this regard, the user may provide input to the computing device through various gestures, such as vision, voice, and motion.

In the present disclosure, various embodiments may be implemented in a computing device including a back-end component (e.g., a data server), a middleware component (e.g., an application server), and/or a front-end component. In this case, the components may be interconnected by any form or medium of digital data communication, such as a communication network. In one embodiment, the communication network may include a wired network such as Ethernet, a power line communication), a telephone line communication device, and RS-serial communication, a wireless network such as a mobile communication network, a wireless LAN (WLAN), Wi-Fi, Bluetooth, and ZigBee, or a combination thereof. For example, the communication network may include a local area network (LAN), a wide area network (WAN), or the like.

The computing device based on the exemplary embodiments described herein may be implemented using hardware and/or software configured to interact with a user, including a user device, a user interface (UI) device, a user terminal, or a client device. For example, the computing device may include a portable computing device such as a laptop computer. Additionally or alternatively, the computing device may include, but is not limited to, a personal digital assistant (PDA), a tablet PC, a game console, a wearable device, an Internet-of-Things (IoT) device, a virtual reality (VR) device, an augmented reality (AR) device, and the like. The computing device may further include other types of devices configured to interact with a user. Furthermore, the computing device may include a portable communication device (e.g., a mobile phone, a smartphone, a wireless cellular phone, and the like) suitable for wireless communication over a network, such as a mobile communication network. The computing device may be configured to wirelessly communicate with a network server using wireless communication technologies such as Radio Frequency (RF), Microwave Frequency (MWF), and/or Infrared Ray Frequency (IRF) and/or protocols.

Various embodiments including specific structural and functional details in the present disclosure are exemplary. Therefore, the embodiments of the present disclosure are not limited to those described above, and may be implemented in various other forms. In addition, the terms used in the present disclosure are intended to describe some embodiments and are not to be construed as limiting the embodiments. For example, singular words and the above may be construed to include plural forms unless the context clearly indicates otherwise.

In the present disclosure, unless otherwise defined, all terms used in this specification, including technical or scientific terms, have the same meaning as commonly understood by a person skilled in the art to which such concepts belong. In addition, commonly used terms, such as terms defined in the dictionary, should be interpreted as having a meaning consistent with the meaning in the context of the relevant technology.

Although the present disclosure has been described in connection with some embodiments herein, various modifications and changes may be made without departing from the scope of the present disclosure as understood by a person skilled in the art to which the present disclosure belongs. In addition, such modifications and changes should be considered to fall within the scope of the claims appended hereto.

What is claimed is:

1. A clock management unit design system using a no-code approach, comprising:
a memory configured to store at least one instruction;
a clock component storage configured to store clock component information constituting a clock management unit;
a hardware code logic storage configured to store hardware code logic for generating a designed clock management unit as hardware code; and
at least one processor configured to execute the at least one instruction stored in the memory,
wherein the at least one instruction comprises instructions to:
set auto clock gating of the clock management unit,
design a new clock instance by setting values of a register field defining a function of the new clock instance based on previously generated clock instance information included in the clock management unit and the clock component information,
activate a function module of the new clock instance based on whether the auto clock gating of the clock management unit is set and the setting values of the register field of the new clock instance, and
generate hardware code for the activated function module, hardware code for a register module for operating the activated function module, hardware code for a port for connecting the register module and the activated function module, and hardware code for connection based on the setting values of the register field of the new clock instance, activated function module information of the new clock instance, and the hardware code logic.

2. The clock management unit design system using the no-code approach according to claim 1, wherein the at least one instruction further comprises instructions to:
activate an adapter function module of the new clock instance when the auto clock gating of the clock management unit is set.

3. The clock management unit design system using the no-code approach according to claim 2, wherein the connection includes a clock line and a handshake signal line.

4. The clock management unit design system using the no-code approach according to claim 1, wherein the at least one instruction further comprises instructions to:
generate the new clock instance based on the previously generated clock instance information and the clock component information,
determine a field value of a base register for setting a basic function of a clock source corresponding to the new clock instance, and
determine a field value of an extension register for setting an extended function of the new clock instance.

5. The clock management unit design system using the no-code approach according to claim 4, wherein the at least one instruction further comprises instructions to:
activate a basic function module for performing the basic function of the new clock instance, and
when the field value of the extension register for setting the extended function of the new clock instance is set to a specific value, activate an extended function module for performing the extended function.

6. The clock management unit design system using the no-code approach according to claim 1, wherein the clock component information comprises:
a basic function module for performing a basic function and an extended function module for performing an extended function for each clock component, an address range allocated to each clock component, an alignment size of each clock component, a base register offset size of each clock component, an extension register offset size of each clock component, and configuration field information for each clock component.

7. The clock management unit design system using the no-code approach according to claim 6, wherein the configuration field information for each clock component comprises a field name, a bit position, a bit size, an access permission, and an initial value.

8. The clock management unit design system using the no-code approach according to claim 6, wherein a start address of the register of the new clock instance is determined as a value obtained by adding a start address and an alignment size of a register of the previously generated clock instance.

9. The clock management unit design system using the no-code approach according to claim 6, wherein the clock component is one of a PLL controller component, a clock divider component, a clock multiplexer component, and a clock gate component.

10. The clock management unit design system using the no-code approach according to claim 9, wherein the clock component is the clock divider component,
the field of the extension register of the new clock instance comprises at least one of a power down field, a throttle field, and a custom field, and
the clock divider component comprises at least one of an override function module, a throttle function module, and a custom function module,

11. The clock management unit design system using the no-code approach according to claim 9, wherein the clock component is the clock multiplexer component,
the field of the extension register of the new clock instance comprises at least one of a throttle field and a custom field, and
the clock multiplexer component comprises at least one of a throttle function module and a custom function module,

12. The clock management unit design system using the no-code approach according to claim 9, wherein the clock component is the clock gate component,
the field of the extension register of the new clock instance comprises at least one of a shortstop field, an early wakeup field, and a custom field, and
the clock gate component comprises at least one of a shortstop function module, an early wakeup function module, and a custom function module.

13. A clock management unit design method using a no-code approach, the method executed using the no-code approach by at least one process in a computer system comprising a clock component storage in which clock component information constituting a clock management unit is stored and a hardware code logic storage in which a hardware code logic for generating a designed clock management unit as hardware code is stored, the method comprising:
setting auto clock gating of the clock management unit,
designing a new clock instance by setting values of a register field defining a function of the new clock instance based on previously generated clock instance information included in the clock management unit and the clock component information,
activating a function module of the new clock instance based on whether the auto clock gating of the clock management unit is set and the setting values of the register field of the new clock instance, and
generating hardware code for the activated function module, hardware code for a register module for operating the activated function module, hardware code for a port for connecting the register module and the activated function module, and hardware code for connection based on the setting values of the register field of the new clock instance, activated function module information of the new clock instance, and the hardware code logic.

14. The clock management unit design method using the no-code approach according to claim 13, further comprising:
activating an adapter function module of the new clock instance when the auto clock gating of the clock management unit is set.

15. The clock management unit design method using the no-code approach according to claim 14, wherein the connection includes a clock line and a handshake signal line.

16. The clock management unit design method using the no-code approach according to claim 13, further comprising:
generating the new clock instance based on the previously generated clock instance information and the clock component information,
determining a field value of a base register for setting a basic function of a clock source corresponding to the new clock instance, and
determining a field value of an extension register for setting an extended function of the new clock instance.

17. The clock management unit design method using the no-code approach according to claim 16, further comprising:
activating a basic function module for performing the basic function of the new clock instance, and
when the field value of the extension register for setting the extended function of the new clock instance is set to a specific value, activating an extended function module for performing the extended function.

18. The clock management unit design method using the no-code approach according to claim 13, wherein the clock component information comprises:
a basic function module for performing a basic function and an extended function module for performing an extended function for each clock component, an address range allocated to each clock component, an alignment size of each clock component, a base register offset size of each clock component, an extension register offset size of each clock component, and configuration field information for each clock component.

19. The clock management unit design method using the no-code approach according to claim 18, wherein the clock component is one of a PLL controller component, a clock divider component, a clock multiplexer component, and a clock gate component.

20. A computer program, stored in a computer-readable medium, for executing the method according to claim 13 on a computer.
